(19) United States
(12) Patent Application Publication
(10) Pub. No.: US 2023/0342694 A1
(43) Pub. Date: Oct. 26, 2023

(54) SYSTEM AND METHOD FOR PROVIDING RESILIENT ENTERPRISE OPERATION AND MANAGEMENT

(71) Applicant: JPMorgan Chase Bank, N.A., New York, NY (US)

(72) Inventor: Tom MARTIN, Lewis Center, OH (US)

(73) Assignee: JPMorgan Chase Bank, N.A., New York, NY (US)

(21) Appl. No.: 17/660,149

(22) Filed: Apr. 21, 2022

(51) Int. Cl. G06Q 10/06; G06N 20/00

(52) U.S. Cl. CPC G06Q 10/0637; G06Q 10/06312; G06Q 10/06313; G06N 20/00

(57) ABSTRACT

A method for providing enterprise resiliency in an organization includes identifying existing assets belonging to the organization; identifying, among the identified assets, a target asset that is projected to be impacted by an event occurring external to the organization; determining, among the identified assets, one or more assets dependent on the target asset; generating one or more enterprise resiliency plans for reducing impact of operations performed by the target asset to the one or more assets dependent on the target asset; performing simulations of the one or more enterprise resiliency plans; generating a report on the performed simulations; selecting an enterprise resiliency plan for implementation based on the generated report; and implementing the enterprise resiliency plan and transmitting notification of the enterprise resiliency plan to responsible members of affected assets.

### TECHNICAL FIELD

This disclosure generally relates to a system and method for providing a resiliency platform with an ability to visualize, plan and facilitate testing/simulation and deployment of capabilities of an organization ecosystem for providing enterprise resiliency.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Various external events, such as natural disasters, societal issues, wars, crime sprees, may impact an organization's ability to run its operations. For example, a massive power outage caused by a natural disaster passing through a region facilitating a data center of the organization may impact the organization's ability to continue its normal operations through the respective data center. Further, such damage may not be limited to the directly impacted asset (i.e., the data center) and may have further reaching impact to downstream assets or resources. Accordingly, an impactful event may render an organization unable to continue its normal operations leading to large down times, loss of functionality and significant financial loss, which may be difficult to recover from.

### SUMMARY

According to an aspect of the present disclosure, a method for providing enterprise resiliency in response to an event is provided. The method includes performing, using a processor and a memory: identifying existing assets belonging to an organization; identifying, among the identified assets, a target asset that is projected to be impacted by an event occurring external to the organization; determining, among the identified assets, one or more assets dependent on the target asset; generating one or more enterprise resiliency plans for reducing impact of operations performed by the target asset to the one or more assets dependent on the target asset; performing simulations of the one or more enterprise resiliency plans; generating a report on the performed simulations; selecting an enterprise resiliency plan for implementation based on the generated report; and implementing the enterprise resiliency plan and transmitting notification of the enterprise resiliency plan to responsible members of affected assets.

According to another aspect of the present disclosure, the method further includes determining a location of the event; and determining whether a location of the target asset correspond with the location of the event.

According to another aspect of the present disclosure, the location of the target asset is determined to correspond with the location of the event when the target asset is located within a predetermined distance from the location of the event.

According to yet another aspect of the present disclosure, the location of the target asset is determined to correspond with the location of the event when the target asset is located within a predetermined distance from a projected path of the event.

According to another aspect of the present disclosure, the target asset is at least one of a building, a computing device, an application or an employee.

According to a further aspect of the present disclosure, the identifying of the existing assets includes identifying asset information of a respective asset, the asset information indicating at least an assigned location of the respective asset.

According to yet another aspect of the present disclosure, the one or more assets dependent on the target asset are determined based on communication paths between the existing assets.

According to a further aspect of the present disclosure, the communication paths between the existing assets are determined using one or more artificial intelligence (AI) or machine learning (ML) algorithms.

According to another aspect of the present disclosure, the method further includes monitoring of the existing assets for detection of a change among the existing assets; and providing notification of the detected change in response to a detection of the change.

According to a further aspect of the present disclosure, the change includes at least adding of a new asset, removing of an existing asset, or reallocating of the existing as set.

According to a further aspect of the present disclosure, the event is a simulated event.

According to a further aspect of the present disclosure, the event is a real-life event.

According to a further aspect of the present disclosure, the generated report includes at least one of resource requirements, timing requirements, a location of impact, assets impacted, and expected costs of implementation.

According to a further aspect of the present disclosure, at least one of the enterprise resiliency plans is based on a simulation that is executed with additional input variables, the additional input variables including at least adding or removing of a resource.

According to another aspect of the present disclosure, at least one of the enterprise resiliency plans is based on a simulation that is executed with additional input variables, the additional input variables including at least adding or removing of a constraint.

According to another aspect of the present disclosure, the method further includes monitoring progression of the event; evaluating whether the monitored event corresponds with a projected behavior of the event; determining whether modification of the enterprise resiliency plan is required based on the evaluating; and generating a modified enterprise resiliency plan based on the determining.

According to another aspect of the present disclosure, the method further includes monitoring progression of the event; evaluating whether the monitored event corresponds with a projected behavior of the event; determining whether a supplemental enterprise resiliency plan is required to be generated based on the evaluating; and generating the supplemental enterprise resiliency plan based on the determining.

According to another aspect of the present disclosure, the one or more enterprise resiliency plans for performing simulation are filtered based on one or more constraints determined based on attributes of the event and attributes of the target asset.

According to another aspect of the present disclosure, a system for providing enterprise resiliency in response to an event is disclosed. The system includes at least one processor; at least one memory; and at least one communication circuit. The at least one processor is configured to perform: identifying existing assets belonging to an organization; identifying, among the identified assets, a target asset that is projected to be impacted by an event occurring external to the organization; determining, among the identified assets, one or more assets dependent on the target asset; generating one or more enterprise resiliency plans for reducing impact of operations performed by the target asset to the one or more assets dependent on the target asset; performing simulations of the one or more enterprise resiliency plans; generating a report on the performed simulations; selecting an enterprise resiliency plan for implementation based on the generated report; and implementing the enterprise resiliency plan and transmitting notification of the enterprise resiliency plan to responsible members of affected assets.

According to another aspect of the present disclosure, a non-transitory computer readable storage medium that stores a computer program for providing enterprise resiliency in response to an event is disclosed. The computer program, when executed by a processor, causing a system to perform a process including identifying existing assets belonging to an organization; identifying, among the identified assets, a target asset that is projected to be impacted by an event occurring external to the organization; determining, among the identified assets, one or more assets dependent on the target asset; generating one or more enterprise resiliency plans for reducing impact of operations performed by the target asset to the one or more assets dependent on the target asset; performing simulations of the one or more enterprise resiliency plans; generating a report on the performed simulations; selecting an enterprise resiliency plan for implementation based on the generated report; and implementing the enterprise resiliency plan and transmitting notification of the enterprise resiliency plan to responsible members of affected assets.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an enterprise resiliency management and analytics system in accordance with an exemplary embodiment.

FIG. 2 illustrates an exemplary diagram of a network environment with an enterprise resiliency management and analytics system in accordance with an exemplary embodiment.

FIG. 3 illustrates a system diagram for implementing an enterprise resiliency management and analytics system in accordance with an exemplary embodiment.

FIG. 4 illustrates a method for providing enterprise resiliency management and analytics in accordance with an exemplary embodiment.

FIG. 5 illustrates a method for deploying enterprise resiliency plans in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

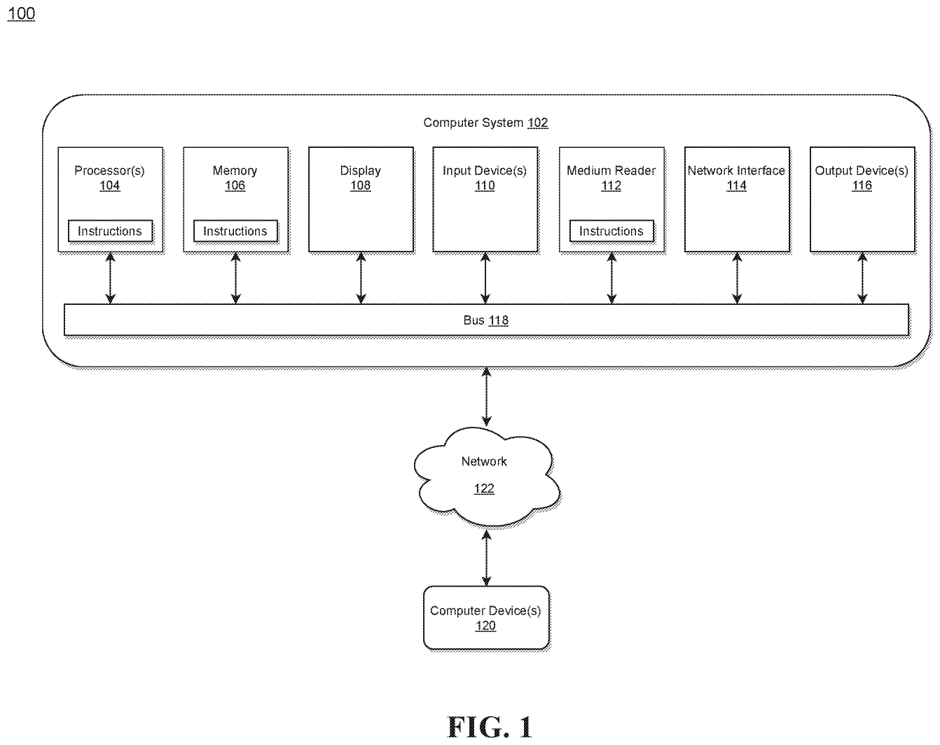

FIG. 1 illustrates a computer system for implementing an enterprise resiliency management and analytics (ERMA) system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

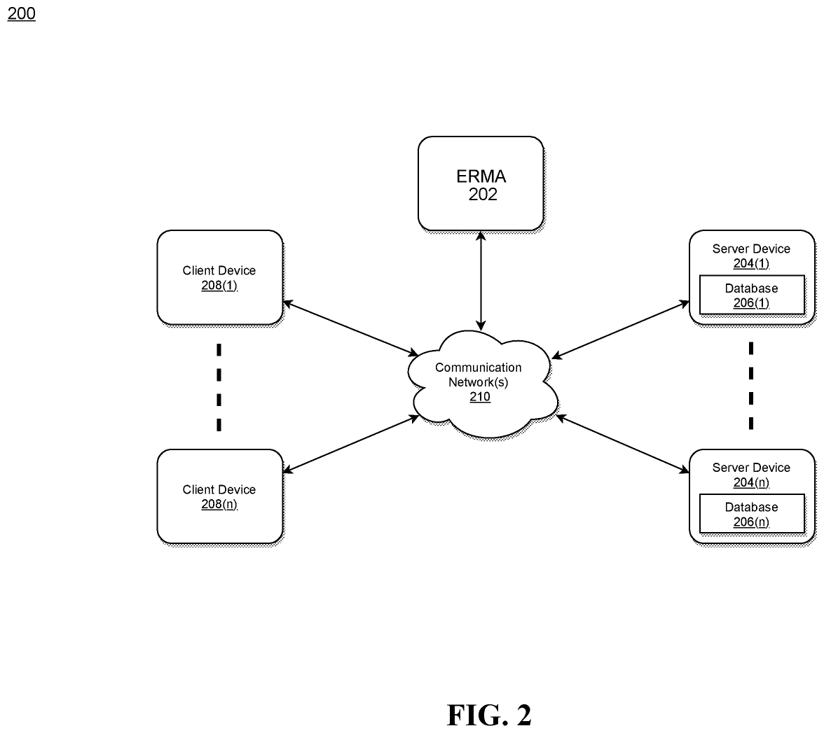

FIG. 2 illustrates an exemplary diagram of a network environment with an enterprise resiliency management and analytics system in accordance with an exemplary embodiment.

An enterprise resiliency management and analytics (ERMA) system 202 may be implemented with one or more computer systems similar to the computer system 102 as described with respect to FIG. 1.

The ERMA system 202 may store one or more applications that can include executable instructions that, when executed by the ERMA system 202, cause the ERMA system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the ERMA system 202 itself, may be located in virtual server(s) running in a cloud-based computing environment rather than being tied to one or more specific physical network computing devices. Also, the application(s) may be running in one or more virtual machines (VMs) executing on the ERMA system 202. Additionally, in one or more embodiments of this technology, virtual machine(s) running on the ERMA system 202 may be managed or supervised by a hypervisor.

In the network environment 200 of FIG. 2, the ERMA system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the ERMA system 202, such as the network interface 114 of the computer system 102 of FIG. 1, operatively couples and communicates between the ERMA system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ERMA system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ERMA system 202 may be a standalone device or integrated with one or more other devices or apparatuses, such as one or more of the server devices 204(1)-204(n), for example. In one particular example, the ERMA system 202 may be hosted by one of the server devices 204(1)-204(n), and other arrangements are also possible. Moreover, one or more of the devices of the ERMA system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ERMA system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the ERMA system 202 that may efficiently provide a platform for implementing a cloud native ERMA system module, but the disclosure is not limited thereto.

The client devices 208(1)-208(n) may run interface applications, such as standard web browsers or standalone client applications, which may provide an interface to communicate with the ERMA system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ERMA system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ERMA system 202, the server devices 204(1)-204(n), or the client devices 208(1)-208(n), for example, may be configured to operate as virtual instances on the same physical machine. For example, one or more of the ERMA system 202, the server devices 204(1)-204(n), or the client devices 208(1)-208(n) may operate on the same physical device rather than as separate devices communicating through communication network(s) 210. Additionally, there may be more or fewer ERMA systems 202, server devices 204(1)-204(n), or client devices 208(1)-208(n) than illustrated in FIG. 2. According to exemplary embodiments, the ERMA system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

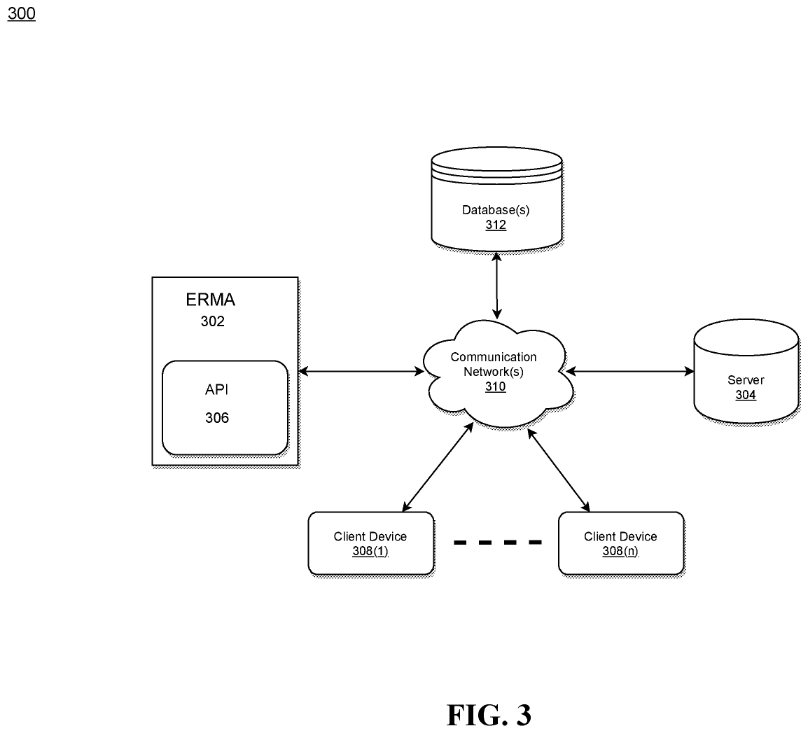

FIG. 3 illustrates a system diagram for implementing a fact verification system in accordance with an exemplary embodiment.

As illustrated in FIG. 3, the system 300 may include a site reliability engineering leaderboard system 302 within which a group of API modules 306 is embedded, a server 304, a database(s) 312, a plurality of client devices 308(1) . . . 308(n), and a communication network 310.

According to exemplary embodiments, the ERMA system 302 including the API modules 306 may be connected to the server 304, and the database(s) 312 via the communication network 310. Although there is only one database has been illustrated, the disclosure is not limited thereto. Any number of databases may be utilized. The ERMA system 302 may also be connected to the plurality of client devices 308(1) . . . 308(n) via the communication network 310, but the disclosure is not limited thereto.

According to exemplary embodiment, the ERMA system 302 is described and shown in FIG. 3 as including the API modules 306, although it may include other rules, policies, modules, databases, or applications, for example. According to exemplary embodiments, the database(s) 312 may be embedded within the ERMA system 302. According to exemplary embodiments, the database(s) 312 may be configured to store configuration details data corresponding to a desired data to be fetched from one or more data sources, user information data etc., but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable ERMA system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the ERMA system 302. In this regard, the plurality of client devices 308(1) . . . 308(n) may be “clients” of the ERMA system 302 and are described herein as such. Nevertheless, it is to be known and understood that the plurality of client devices 308(1) . . . 308(n) need not necessarily be “clients” of the ERMA system 302, or any entity described in association therewith herein. Any additional or alternative relationship may exist between either or both of the plurality of client devices 308(1) . . . 308(n) and the ERMA system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the ERMA system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ERMA system 302 may be the same or similar to the ERMA system 202 as described with respect to FIG. 2, including any features or combination of features described with respect thereto.

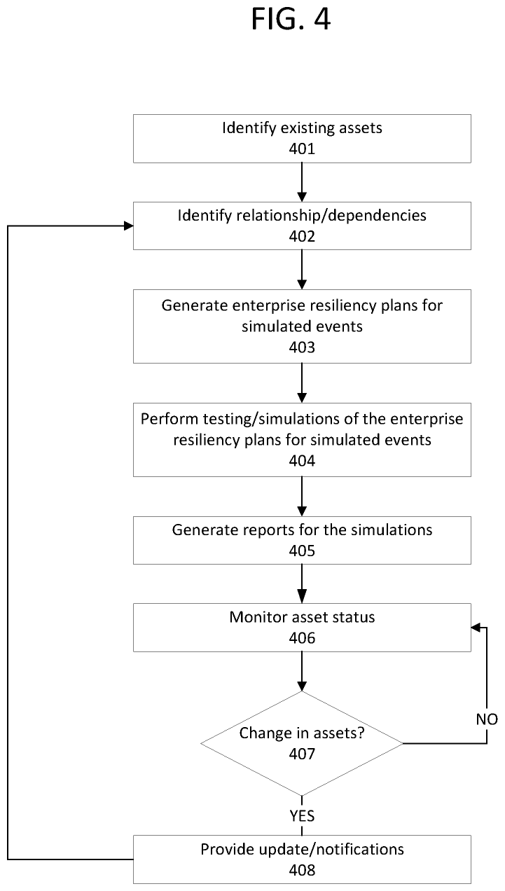

FIG. 4 illustrates a method for providing enterprise resiliency management and analytics (ERMA) in accordance with an exemplary embodiment.

Exemplary aspects of the present application are directed to providing a cloud based data driven system and method, which leverage a common set of firmwide data, to provide stakeholders with a comprehensive view of the connections and dependencies cross an organization. Exemplary aspects further provide an intuitive interface that sits on top of the integrated data model, to (i) allow users to capture and maintain information about the organization's various assets, services and activities performed across the organization, (ii) conduct business/organization impact analysis, and (iii) allow for risk-based planning in alignment to the business/function's needs in order to support decision making in the event of a crisis for maintaining enterprise resiliency.

Moreover, further aspects of the present application provide that the ERMA system may allow for facilitation of testing and/or simulations at various levels of the organization to ensure that plans in response to various events of events (e.g., natural disaster, social unrest, and etc.) are sufficient, effective and align to the defined business impact analysis operating levels. Further, the ERMA system may also allow various simulations to be executed for modified plans. For example, simulations may be run with variable inputs to run various ‘what-if’ scenarios for identifying the best suited plan in response to an event or crisis.

According to further aspects, the ERMA system provides response support through flexible reporting, which provide users an ability to access information that is fit for purpose and readily accessible, enabling an organization to effectively manage enterprise resiliency plans, provide transparency into the overall enterprise resiliency across the organization and inform the planning of the decision-making process during an event or crisis.

In operation 401, identification of various assets of an organization may be performed. According to exemplary aspects, assets of an organization may include buildings, data centers, computing devices, applications, employees, and the like. However, aspects of the present disclosure are not limited thereto, such that assets may include external service providers, vendors, and/or customers. With respect to application assets, an organization may include various applications that may be hosted across various locations and heterogeneous platforms, such as legacy infrastructure, private cloud network, public cloud network, which may pass through various data centers. Each of the identified asset may form a node on an organization map. Further, each of the identified assets may be assigned to a particular location. However, aspects of the present disclosure are not limited thereto, such that each asset may include various attributes, such as organization information, responsible personnel/team, and other information related to the asset.

According to exemplary aspects, various data nodes or assets may be identified via an automated mining operation for each platform/environment of an organization's ecosystem for obtaining resources data of various assets included in the organization's ecosystem. In an example, asset information may be obtained for each of the identified assets. Asset information may include, without limitation, identification information, asset type information, and communications with other assets.

In operation 402, dependencies of the identified assets or organizational nodes may be identified. For example, when one node or asset fails, various downstream nodes or assets may be impacted. However, aspects of the present disclosure are not limited thereto, such that one or more upstream nodes or assets may also be impacted. Accordingly, an impact of a failure of a particular node or asset (e.g., a data center) may be large spanning across multiple nodes or assets.

In an example, relationships or dependencies between identified assets may be determined based on communications performed with other assets, organizational chart or based on manual settings. Moreover, relationships or dependencies may further be determined based on load balancing, communications with other assets, interconnectivity or the like. For example, in a cloud architecture, an internal cloud may be locked down to restrict access. In such cloud architecture, specific ports may be required to be opened before any asset may connect to it. At least since firewall has to be opened up to provide such connection, information of the connecting asset may be obtained. Further, asset information may also be gathered based on user operations.

According to exemplary aspects, relationships or dependencies between the identified assets may be determined automatically during a scanning process. However, aspects of the present disclosure are not limited thereto, such that the relationships or dependencies may be manually established, and further edited or modified after the auto mining operation is completed.

Moreover, the relationships and/or dependencies between various assets may be determined using one or more artificial intelligence (AI) or machine learning (ML) algorithms. In an example, AI or ML algorithms may be executed to perform data pattern detection, and to provide an output or render a decision (e.g., identification of a fact to be extracted) based on the data pattern detection. More specifically, an output may be provided based on a historical pattern of data, such that with more data or more recent data, more accurate outputs and/or decisions may be provided or rendered. Accordingly, the ML or AI models may be constantly updated after a predetermined number of runs or iterations. According to exemplary aspects, machine learning may refer to computer algorithms that may improve automatically through use of data. Machine learning algorithm may build an initial model based on sample or training data, which may be iteratively improved upon as additional data are acquired.

More specifically, machine learning/artificial intelligence and pattern recognition may include supervised learning algorithms such as, for example, k-medoids analysis, regression analysis, decision tree analysis, random forest analysis, k-nearest neighbors analysis, logistic regression analysis, k-fold cross-validation analysis, balanced class weight analysis, and the like. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, and the like.

In another exemplary embodiment, the ML or AI model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the ML or AI model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the ML or AI models may be generated using at least one from among an artificial neural network technique, a decision tree technique, a support vector machines technique, a Bayesian network technique, and a genetic algorithms technique.

In operation 403, one or more enterprise resiliency plans are generated for an asset (e.g., a data center) based on the asset relationships or dependencies, historical data and other event related information (e.g., moving speed/path of a hurricane). According to exemplary aspects, historical data may provide insight into amount of lead time, resource involvement, financial costs and the like required for executing such a plan. In an example, the enterprises resiliency plans may be generated using one or more ML or AI algorithms and in consideration of the above noted information. For example, an enterprise resiliency plan may indicate diverting traffic from a data center that is to be impacted in view of an event (e.g., a data center located along a path of a hurricane) to one or more of other data centers based on traffic volume and performance requirements. An enterprise resiliency plan may specify a time frame at which the plan is to be executed, personnel requirements and the like. Although ML or AI algorithm derived enterprise plans are disclosed above, aspects of the present disclosure are not limited thereto, such that an enterprise plan may be manually generated or may be a previously executed plan.

In operation 404, one or more enterprise resiliency plan may be tested or simulated in a testing environment. Moreover, various modifications (e.g., data centers through which to direct traffic) to the enterprise resiliency plan may be simulated to obtain differing results for identifying an optimal plan to implement. For example, additional resources or constraints may be added or removed from an enterprise resiliency plan in a simulation for attaining desired or improved results. The additional resources may be an asset of an organization that may not have a relationship with the impacted assets or may be external to the organization, which may be procured for implementing an enterprise resiliency plan.

In operation 405, one or more reports may be generated for the executed simulations. In an example, the generated reports may indicate viability of the simulated plans, resource requirements, time requirements, and financial impact. Based on the provided metrics, stake holders may select an enterprise plan based on effectiveness, financial impact and/or resource constraints. However, aspects of the present disclosure are not limited thereto, such that one or more ML or AI algorithms may be executed to select an optimal enterprise plan based on the organization's situation. For example, if insufficient number of employees are available for implementing an enterprise resiliency plan due to mandatory evacuations, another enterprise resiliency plan with less man-power requirement may be selected even if other metrics may be lower.

In operation 406, assets may be monitored for identifying changes to the respective assets. In an example, assets may be monitored in real-time in a continuous manner, or may be monitored at predetermined intervals. Moreover, monitoring of assets may be performed in response to an event, such as adding of a new asset.

In operation 407, a determination of whether there has been a change to one or more assets is performed. For example, a change in an asset may include, without limitation, adding of an asset, removal of an asset, modification of an asset attribute (e.g., reassigned to a differing location), adding of a dependency or relationship, modification of a dependency or relationship, or the like.

If no change to the assets is determined in operation 407, monitoring of assets is resumed in operation 406.

On the other hand, if a change in the assets is detected in operation 407, an update or notification of the change may be provided to all of the related assets in operation 408, and the method proceeds back to operation 402 for identifying modified relationships or dependencies between the assets including the asset for which the change is detected.

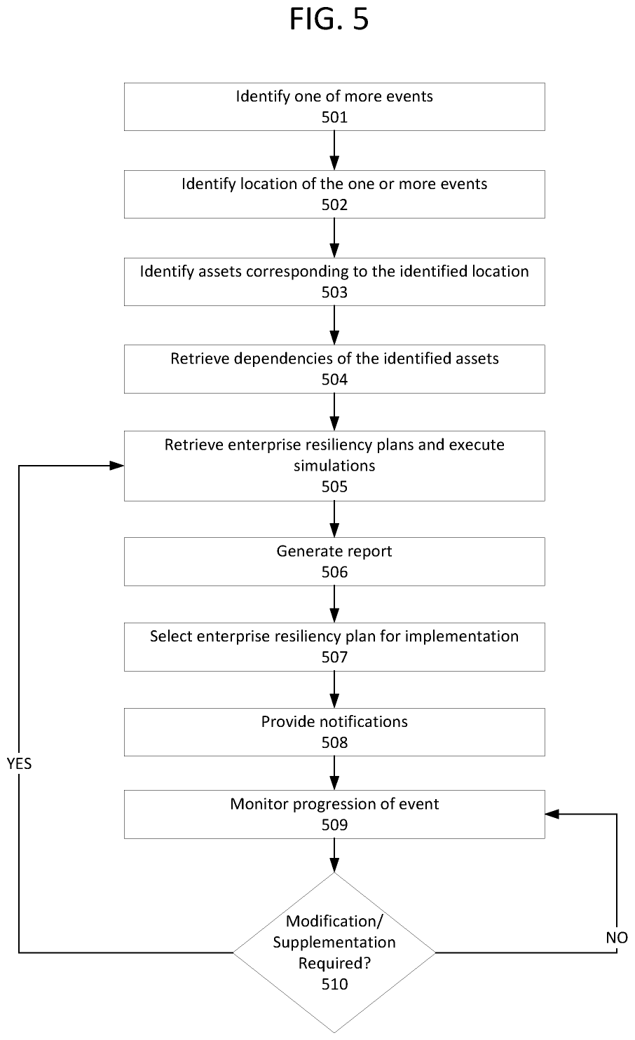

FIG. 5 illustrates a method for deploying enterprise resiliency plans in accordance with an exemplary embodiment.

In operation 501 one or more events that may impact an operation of an asset of an organization is detected. According to exemplary aspects, one or more events may include, without limitation, a natural disaster, social unrest, war, fire, or any event that may disrupt normal business or enterprise operations of the impacted asset of the organization. Although the present disclosure is provided with respect to external events impacting normal operations, aspects of the present disclosure are not limited thereto, such that internally driven events (e.g., renovation of an asset facility, adding of a new data center, retiring of an asset or the like) may also be included.

In operation 502, location of the one or more events identified is identified. Location of the one or more events may include a predetermined perimeter of the identified event or events. The predetermined perimeter may be based on one or more attributes of the identified event or events. For example, a higher level hurricane will have a larger perimeter than a lower level hurricane. Location may further include one or more routes within a proximate distance of the identified event or events. However, as such events may not be limited to a fixed location, the location of the one or more events identified may further include projected or possible paths of the identified event or events. Projected or possible paths of the one or more events may be determined based on computer or simulation modeling. Further, such paths may further be determined or modified in view of one or more AI or ML algorithms.

In operation 503, one or more assets corresponding to the identified location are identified. For example, assets corresponding to the identified location of the event may be determined based on asset information, which may indicate an assigned location. According to exemplary aspects, assets may be indicated as being corresponding to the identified location of the event if the asset is determined to be located within a predetermined distance from the location of the identified event or events.

In operation 504, assets related to or dependent from the one or more assets identified in operation 503 are retrieved from a server. However, aspects of the present disclosure are not limited thereto, such that relationship or dependencies with respect to other assets may be dynamically determined based on the location or travel path of the identified event or events.

In operation 505, one or more enterprise resiliency plans are retrieved for the identified asset and corresponding dependencies, and simulations may be performed for one or more of the enterprise resiliency plans. Although the present disclosure provides retrieval of enterprise resiliency plans, aspects of the present disclosure are not limited thereto, such that one or more enterprise resiliency plans may be dynamically determined based on the current information, such as impacted assets, dependencies, location of event, travel path of event and the like. Moreover, a combination of retrieved enterprise resiliency plans and dynamically generated enterprise resiliency plans may be aggregated for performing simulations. Further, the enterprise resiliency plans may be retrieved or generated based on one or more constraints. For example, time until impact of the event with the identified asset may dictate which of the enterprise resiliency plans may be available for simulation and eventual implementation.

Upon performing simulations of the one or more enterprise resiliency plans are performed, modified simulations may be additionally performed based on various ‘what-if’ scenarios. For example, modified simulations may be performed by inputting additional constraints or resources that may not have been previously accounted for. In an example, the additional constraints or resources may be added or removed by one or more AI or ML algorithms for identifying ideal solutions that may potentially be achieved. The additional constraints or resources for achieving the ideal solutions may identified in a formal report.

In operation 506, one or more report may be generated based on the simulations. For example, the generated report may specify, without limitation, the event, location of the event, projected path of event, possible outcome scenarios with probabilities, assets impacted, financial impact, amount of down time, resources required for implementation of the enterprise resiliency plan, time requirements for implementing the enterprise resiliency plan and the like. Moreover, the generated report may additionally specify additional or external constraints and resources that may potentially be added or removed by the organization for providing additional benefits, and quantification of the additional benefits.

In operation 507, an enterprise resiliency plan is selected for implementation. Although a single enterprise resiliency plan is disclosed as being selected, aspects of the present disclosure are not limited thereto, such that more than one enterprise resiliency plan may be selected for implementation.

In operation 508, corresponding notifications may be sent to the impacted parties and assets. For example, an employee or team responsible for an impacted asset (e.g., legacy system, data center or the like) may be notified of the event and the enterprise resiliency plan to be implemented, as well as its impact on their operations, if any. In an example, if the asset is an employee, evacuation plans and new work location assignment may be provided. In addition, impacted external vendors and/or customers may additionally be notified. According to exemplary aspects, notifications may be sent in accordance with communication preferences indicated in a personnel profile. Notification may be sent, without limitation, via email, text message, voice message, or the like. Further, the notifications may be repeatedly sent at predetermined intervals until receipt confirmation has been received.

In operation 509, progression of the event may be tracked to ensure that the selected enterprise resiliency plan still corresponds to the simulated behavior or impact of the event, such as a travel path or strength of a hurricane.

In operation 510, a determination is made whether modification or supplementation to the enterprise resiliency plan selected to be implemented would be necessary. If modification or supplementation is determined to be required in operation 510, the method proceeds back to operation 505 for generating or retrieving of modified enterprise resiliency plan or generating or retrieving of supplemental enterprise resiliency plan, and performing simulations thereof. On the other hand, if modification or supplementation is determined not to be required with the progression of the identified event, then continued monitoring of the progression of the event is performed in operation 509.

Further, although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A method for providing enterprise resiliency, the method comprising:
performing, using a processor and a memory:
identifying existing assets belonging to an organization, wherein the assets include at least a data center, and wherein each of the assets forms a node on an organization map;
identifying, among the identified assets, a target asset that is projected to be impacted by an event occurring external to the organization, wherein the event is a physical event;
determining, among the identified assets, one or more assets dependent on the target asset;
generating one or more enterprise resiliency plans for reducing impact of operations performed by the target asset to the one or more assets dependent on the target asset;
performing simulations of the one or more enterprise resiliency plans;
generating a report on the performed simulations;
selecting an enterprise resiliency plan for implementation based on the generated report; and
implementing the enterprise resiliency plan and transmitting notification of the enterprise resiliency plan to responsible members of affected assets, wherein the implementing of the enterprise resiliency plan includes diverting network traffic from the target asset to another data center to maintain the network traffic.

2. The method according to claim 1, further comprising;
determining a location of the event; and
determining whether a location of the target asset correspond with the location of the event.

3. The method according to claim 2,
wherein the location of the target asset is determined to correspond with the location of the event when the target asset is located within a predetermined distance from the location of the event.

4. The method according to claim 2,
wherein the location of the target asset is determined to correspond with the location of the event when the target asset is located within a predetermined distance from a projected path of the event.

5. The method according to claim 1,
wherein the target asset is at least one of a building, a computing device, an application or an employee.

6. The method according to claim 1,
wherein the identifying of the existing assets includes identifying asset information of a respective asset, the asset information indicating at least an assigned location of the respective asset.

7. The method according to claim 1,
wherein the one or more assets dependent on the target asset are determined based on communication paths between the existing assets.

8. The method according to claim 7,
wherein the communication paths between the existing assets are determined using one or more artificial intelligence (AI) or machine learning (ML) algorithms.

9. The method according to claim 1, further comprising:
monitoring of the existing assets for detection of a change among the existing assets; and
providing notification of the detected change in response to a detection of the change.

10. The method according to claim 9,
wherein the change includes at least adding of a new asset, removing of an existing asset, or reallocating of the existing asset.

11. The method according to claim 1,
wherein the event is a simulated event.

12. The method according to claim 1,
wherein the event is a real-life event.

13. The method according to claim 1,
wherein the generated report includes at least one of resource requirements, timing requirements, a location of impact, assets impacted, and expected costs of implementation.

14. The method according to claim 1, wherein at least one of the enterprise resiliency plans is based on a simulation that is executed with additional input variables, the additional input variables including at least adding or removing of a resource.

15. The method according to claim 1, wherein at least one of the enterprise resiliency plans is based on a simulation that is executed with additional input variables, the additional input variables including at least adding or removing of a constraint.

16. The method according to claim 1, further comprising:
monitoring progression of the event;
evaluating whether the monitored event corresponds with a projected behavior of the event;
determining whether modification of the enterprise resiliency plan is required based on the evaluating; and
generating a modified enterprise resiliency plan based on the determining.

17. The method according to claim 1, further comprising:
monitoring progression of the event;
evaluating whether the monitored event corresponds with a projected behavior of the event;
determining whether a supplemental enterprise resiliency plan is required to be generated based on the evaluating; and
generating the supplemental enterprise resiliency plan based on the determining.

18. The method according to claim 1, wherein the one or more enterprise resiliency plans for performing simulation are filtered based on one or more constraints determined based on attributes of the event and attributes of the target asset.

19. A system for providing enterprise resiliency, the system comprising:
at least one processor;
at least one memory; and
at least one communication circuit,
wherein the at least one processor performs:
identifying existing assets belonging to an organization, wherein the assets include at least a data center, and wherein each of the assets forms a node on an organization map;
identifying, among the identified assets, a target asset that is projected to be impacted by an event occurring external to the organization, wherein the event is a physical event;
determining, among the identified assets, one or more assets dependent on the target asset;
generating one or more enterprise resiliency plans for reducing impact of operations performed by the target asset to the one or more assets dependent on the target asset;
performing simulations of the one or more enterprise resiliency plans;
generating a report on the performed simulations;
selecting an enterprise resiliency plan for implementation based on the generated report; and
implementing the enterprise resiliency plan and transmitting notification of the enterprise resiliency plan to responsible members of affected assets, wherein the implementing of the enterprise resiliency plan includes diverting network traffic from the target asset to another data center to maintain the network traffic.

20. A non-transitory computer readable storage medium that stores a computer program for providing enterprise resiliency, the computer program, when executed by a processor, causing a system to perform a process comprising:
identifying existing assets belonging to an organization, wherein the assets include at least a data center, and wherein each of the assets forms a node on an organization map;
identifying, among the identified assets, a target asset that is projected to be impacted by an event occurring external to the organization, wherein the event is a physical event;
determining, among the identified assets, one or more assets dependent on the target asset;
generating one or more enterprise resiliency plans for reducing impact of operations performed by the target asset to the one or more assets dependent on the target asset;
performing simulations of the one or more enterprise resiliency plans;
generating a report on the performed simulations;
selecting an enterprise resiliency plan for implementation based on the generated report; and
implementing the enterprise resiliency plan and transmitting notification of the enterprise resiliency plan to responsible members of affected assets, wherein the implementing of the enterprise resiliency plan includes diverting network traffic from the target asset to another data center to maintain the network traffic.
